(19) United States
(12) Patent Application Publication
(10) Pub. No.: US 2024/0361147 A1
(43) Pub. Date: Oct. 31, 2024

(54) UPDATING MAP DATA BASED ON ROAD AND TRAFFIC CONTROL FEATURES

(71) Applicant: GM Cruise Holdings LLC, San Francisco, CA (US)

(72) Inventors: Kenn Cartier, Redmond, WA (US); Joseph Reid, Richmond, CA (US)

(73) Assignee: GM Cruise Holdings LLC, San Francisco, CA (US)

(21) Appl. No.: 18/309,553

(22) Filed: Apr. 28, 2023

(51) Int. Cl. G01C 21/00; B60W 30/18; B60W 50/14; B60W 60/00; G01C 21/36

(52) U.S. Cl. CPC G01C 21/3815; B60W 30/18159; B60W 50/14; B60W 60/001; G01C 21/3658; G01C 21/3896; B60W 2050/146; B60W 2556/40; B60W 2556/50

(57) ABSTRACT

Patterns in lane data and traffic signal data around intersections are used to detect potential errors in map databases and automatically generate data for map databases. Groups of lanes inbound into intersections and/or outbound from intersections can be categorized, and these categories may be used to compare lanes around an intersection, or at multiple intersections along a roadway or in a region. Deviations from expected patterns of these intersection categories may be used to identify errors. Patterns of internal lanes based on external lanes and traffic signal data may be used to automatically generate internal lane data for intersections.

### BACKGROUND

### 1. Technical Field

The present disclosure generally relates to map databases for autonomous vehicles and, more specifically, to using classification of roads and traffic control features to improve and generate map data.

### 2. Introduction

An autonomous vehicle (AV) is a motorized vehicle that may navigate without a human driver. An exemplary AV may include various sensors, such as a camera sensor, a light detection and ranging (LIDAR) sensor, and a radio detection and ranging (RADAR) sensor, among others. The sensors collect data and measurements that the AV may use for operations such as navigation. The sensors may provide the data and measurements to an internal computing system of the AV. The computing system may execute software that uses the data and measurements to control a mechanical system of the AV, such as a vehicle propulsion system, a braking system, or a steering system.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example map database, according to some examples of the present disclosure;

FIG. 2 illustrates an example map data review system, according to some examples of the present disclosure;

FIGS. 3A and 3B illustrate two sets of internal lanes across two example intersections, according to some examples of the present disclosure;

FIGS. 4A and 4B illustrate two example sets of traffic control signals at an example intersection, according to some examples of the present disclosure;

FIGS. 5A and 5B illustrate two example sets of three intersections along a roadway, according to some examples of the present disclosure;

FIG. 6 illustrates an example process for adding internal lane data to a map database, according to some examples of the present disclosure;

FIG. 7 illustrates an example process for updating a map database with correct traffic light data, according to some examples of the present disclosure;

FIG. 8 illustrates an example process for updating a map database with correct lane data, according to some examples of the present disclosure;

FIG. 9 illustrates an example system environment that may be used to facilitate autonomous vehicle (AV) operations, according to some aspects of the disclosed technology;

FIG. 10 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs use a mix of hardware and software to accomplish navigating and driving tasks without a human driver. AVs include computing circuitry in one or more processing units, such as central processing units (CPUs) and/or graphical processing units (GPUs), which run software for processing data and controlling the AV. AVs typically include a variety of sensors to perceive their environment, including RADAR, LIDAR, and cameras. These sensors provide a 360-degree view of the AV's surroundings. The sensor data is provided to computing circuitry (e.g., the CPU or GPU), which runs perception software that processes the sensor data and detects pedestrians, other vehicles, and other objects in the AV's environment. This sensor data and/or additional sensor data, such as a global positioning system (GPS) sensor, accelerometer data, etc., can be used by localization software executing on computing circuitry to determine a precise location of the AV.

In addition to the real-time sensor data, the AV's computing circuitry relies on a highly detailed map to navigate its environment. The map data typically includes data describing routable roadways, such as geospatial information about lanes, and maneuvers that may be performed along or between lanes. The map data further includes traffic control data, such as the locations and types of traffic signs and traffic lights. The AV's computing circuitry may execute path planning software, which uses the sensor data, AV location, and local map data to plan a path for the AV to follow. The AV's computing circuitry may also execute control software that generates instructions to control the vehicle's acceleration, braking, and steering based on the planned path, allowing the AV to navigate its environment and avoid any detected obstacles.

It is important for the map data to be accurate so that the AV is aware of the roadway geometry and driving rules and conventions, such as permitted direction of travel, and permitted maneuvers through an intersection. In addition to detailed lane data, the map data may include data describing traffic controls, such as traffic signs (e.g., stop signs) and traffic lights. Correct labeling of traffic lights in the map database enables AVs to read the appropriate signal, e.g., to look for a turning arrow signal at the traffic control that signals the current lane of the AV.

Generating detailed map data has previously been a highly manual process. Humans review maps and images of roadways and intersections and code various features of the roadways and intersections. For example, a map database may include data describing, for a given lane, a direction of travel of the lane, a speed limit of the lane, geometric boundaries of the lane. At an intersection, the map database may include data describing maneuvers that vehicles may make from different lanes (e.g., straight lanes, turning lanes) and paths that vehicles may take through the intersection. The map database may further include data describing the placement and types of traffic signals.

The need to create highly detailed maps for AVs to navigate makes it difficult for AV operators to scale. In particular, the need for detailed maps across a region creates a high bar to introducing AV fleets into new regions, since generating maps using human labeling is resource-intensive and time consuming. Furthermore, errors may be present in human-generated labels. The identification of certain features may be machine-assisted, e.g., a computer may draw certain lane boundaries based on images (e.g., birds-eye imagery of roadways that have painted lanes), or a computer may identify traffic signals in images obtained by AVs and associate traffic signals with roads or lanes. However, this automatically generated data may also include errors.

As described herein, various properties of intersections often follow patterns, and deviations from these patterns can be used to detect potential errors in map data. For example, four-way intersections often have rotational symmetry of inbound lanes, while three-way intersections often have mirror symmetry of inbound lanes. As another example, along a given roadway, it is common for adjacent intersections to have similar patterns in inbound lanes at corresponding positions. Furthermore, there is a relationship between traffic signals and inbound lane types, and in particular, turn maneuvers that can be performed from inbound lanes. Mismatches between the traffic signal data and arrangement of turning lanes can indicate potential errors in the map data. In some cases, these patterns and relationships may be used to automatically generate map data, e.g., to generate data describing paths or lanes internal to an intersection based on data describing lanes external to the intersection. The error detection methods and map data generation methods described herein can improve the quality and accuracy of map data, and increase the efficiency with which highly detailed maps can be produced.

### Example Map Data

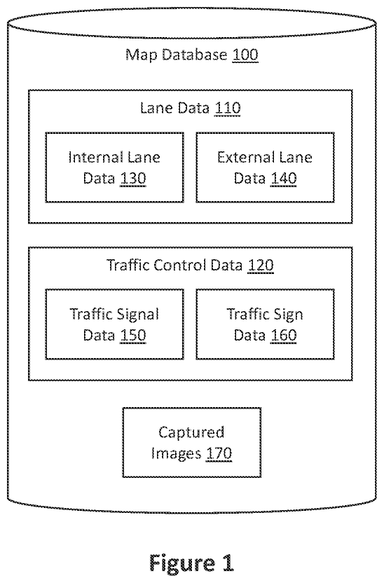

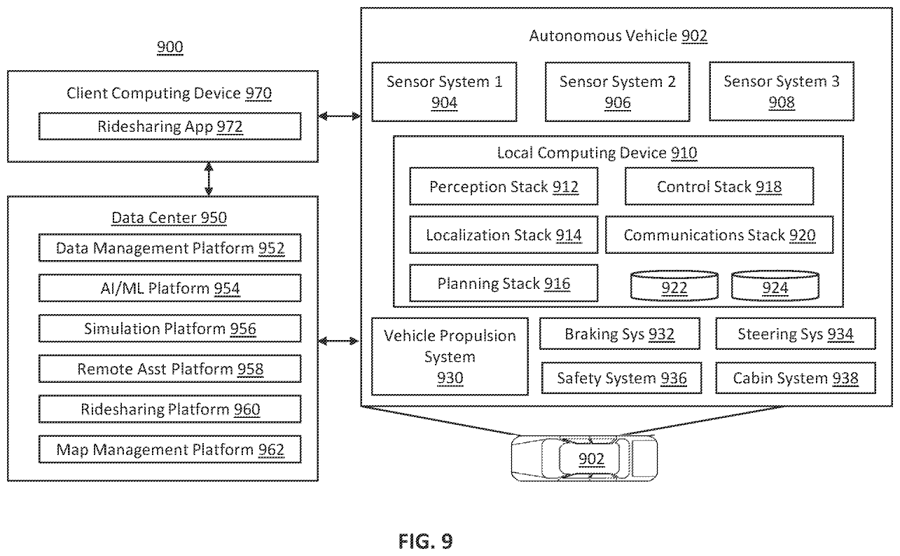

FIG. 1 illustrates an example map database 100, according to some examples of the present disclosure. The map database 100 includes lane data 110 and traffic control data 120. In some embodiments, the map database 100 further includes captured images 170. The map database 100 may be an example of the High Definition (HD) geospatial database 922, described with respect to FIG. 9. The full map database 100, or multiple map databases (e.g., different map databases for different cities or regions covered by an AV service) may be stored by the data center 950. One or more portions of the map database 100 may be stored on an AV. e.g., the AV 902, and used for navigation of the AV 902. The map database 100 may further include additional data not shown in FIG. 1, e.g., any of the data described below with respect to the HD geospatial database 922.

The lane data 110 includes internal lane data 130, which refers to data describing lanes internal to intersections (e.g., lanes within the boundaries of an intersection and serving as pathways through the intersection) and external lane data 140, which refers to data describing lanes between intersections, or otherwise external to intersections (e.g., lanes outside the boundaries of an intersection). The lane data 110 may include, for internal lanes and external lanes, geospatial data of the lane (e.g., lane centerline, lane boundaries, type of lane boundaries, slope, elevation, curvature, etc.) and other lane attributes (e.g., direction of travel, speed limit, lane type, etc.). External lane data 140 for lanes leading into an intersection may include data describing crosswalks and stop lines. External lane data 140 for lanes leading into an intersection may further include data describing maneuvers from the lane, such as permissive, protected/permissive, or protected only left turn lanes; permissive, protected/permissive, or protected only U-turn lanes; permissive or protected only right turn lanes; etc.

The traffic control data 120 includes traffic signal data 150 and traffic sign data 160. Traffic signal data 150 describes traffic signals, which refers to traffic control devices that can change signal or state, such as traffic lights. Traffic sign data 160 describes traffic signs, which refers to static traffic controls, such as stop signs and yield signs. The traffic control data 120 may include, for each signal or sign, a location of the signal or sign. The traffic control data 120 may further identify one or more lanes associated with the signal or sign, i.e., a lane and/or maneuver directed by a traffic signal or sign. In some embodiments, traffic control data 120 further includes data describing pedestrian controls (e.g., data describing pedestrian signals or signs directed to pedestrians), data describing train signals, data describing bus signals or signs, or data describing other signals or signs that control movement on roadways.

In some embodiments, the map database 100 further includes captured images 170. The captured images 170 may include birds-eye or aerial views, such as images taken by cameras mounted to drones, aircraft, or satellites. The captured images 170 may additionally or alternatively include lower angle views, such as images obtained by AVs or other road vehicles. Each captured image 170 may be associated with a location, e.g., a camera location and a field of view (e.g., a direction in which the camera was pointing when the image was captured), or a location or range of locations visible within the captured image. In some cases, the captured images 170 may include visualizations of data captured by other sensors, such as point clouds captured by LIDAR or RADAR. In some embodiments, the captured images 170 are stored outside the map database 100, e.g., in a separate road image database. In some embodiments, the captured images 170 are retrieved from an external data source.

### Example Map Data Review System

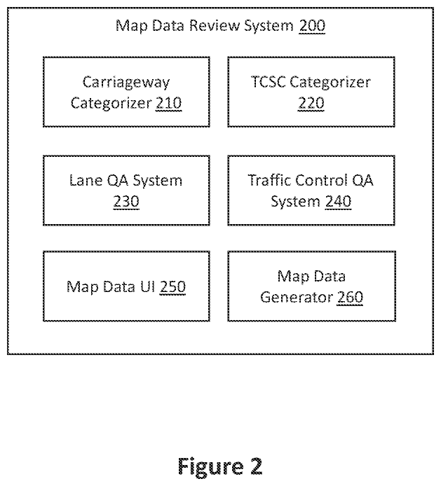

FIG. 2 illustrates an example map data review system 200, according to some examples of the present disclosure. The map data review system 200 includes a carriageway categorizer 210, a traffic control signal constellation (TCSC) categorizer 220, a lane quality assurance (QA) system 230, a traffic control QA system 240, a map data user interface (UI) 250, and a map data generator 260. The map data review system 200 may be part of the map management platform 962, described with respect to FIG. 9. The map data review system 200 may further include additional components not illustrated in FIG. 2, and in other embodiments, certain components shown in FIG. 2 may be omitted from the map data review system 200. In still other embodiments, the components of the map data review system 200 may be distributed in different ways, e.g., the lane QA system 230, traffic control QA system 240, and (optionally) the map data UI 250 may be components of a map data QA system that relies on an external carriageway categorizer 210 and TCSC categorizer 220, while the map data generator 260 may be a separate system that relies on the categorizers 210 and/or 220.

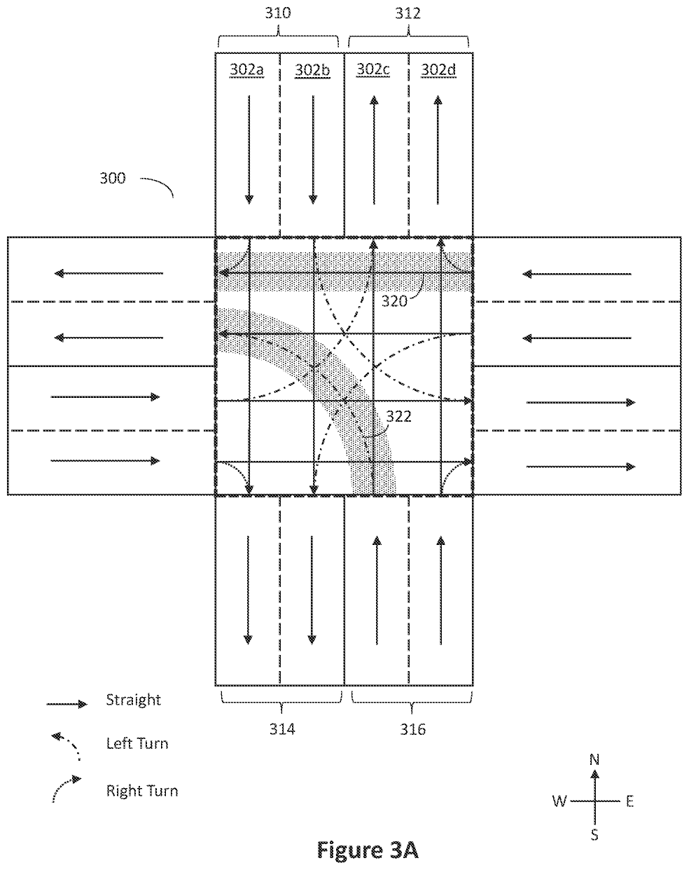

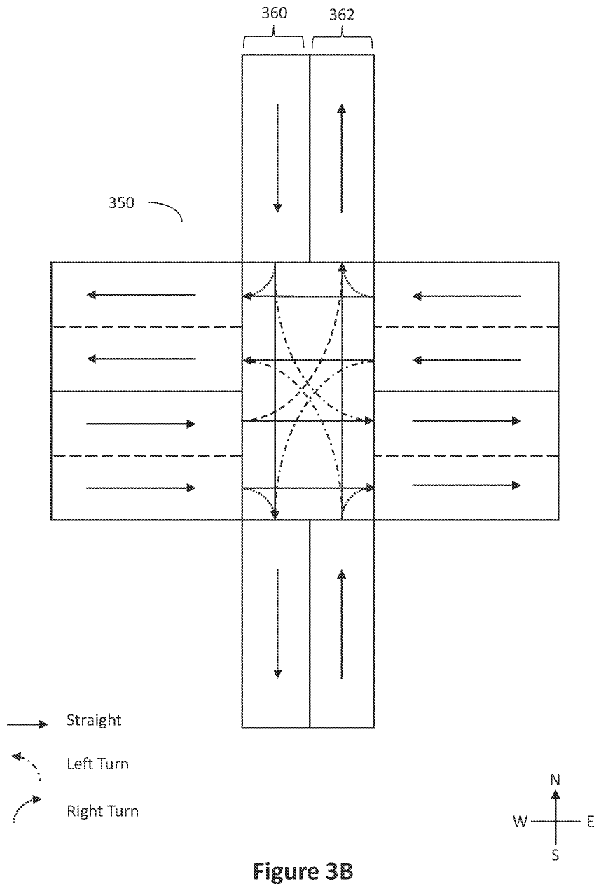

The carriageway categorizer 210 identifies and categorizes carriageways in the lane data 110, and in particular, for external lanes described in the external lane data 140. As used herein, a carriageway refers to a set of one or more external lanes that travel in the same direction along a roadway. For example, a four-lane road typically includes two carriageways traveling in opposite directions, where each carriageway includes two lanes. FIGS. 3A-5, described below, illustrate example intersections, including carriageways traveling into and out of the intersections.

The carriageway categorizer 210 may identify carriageways within the lane data 110 and determine a category for the identified carriageways based on the lane data 110. A carriageway category may be defined by the traffic flow patterns to or from the carriageway. Said another way, a carriageway category may be based on a set of internal lanes that emerge from the head of an inbound carriageway or converge into the tail of an outbound carriageway. A set of internal lanes connected to a specific inbound or outbound lane may be referred to as sibling lanes. A particular set of traffic flow patterns may be assigned a particular carriageway category identifier, such as a number, a letter, or an alphanumeric code. The carriageway categories may be used to provide efficient comparison between intersections along a roadway. It is common for adjacent intersections along a roadway to have the same set of associated carriageway categories, and the carriageway categories may be used to identify data anomalies, as described further below.

As one example, to determine the carriageway category for an inbound carriageway described by the external lane data 140, the carriageway categorizer 210 may identify, for each inbound lane in the inbound carriageway, all of the internal sibling lanes connected to the inbound lane. The carriageway categorizer 210 may retrieve the internal sibling lane data from the internal lane data 130. A particular set of internal sibling lanes emerging from the inbound carriageway may be associated with a particular carriageway category. For example, if an inbound carriageway with one lane has sibling lanes for a right maneuver, a straight maneuver, and a left maneuver, this can represent one carriageway category (e.g., category A).

As another example, to determine the carriageway category for an inbound carriageway described by the external lane data 140, the carriageway categorizer 210 may first compile the set of sibling-lane types as positioned across the carriageway, based on internal lane data 130. For example, an inbound carriageway includes three lanes numbered as lane position 1 from the left side of the road to lane position 3 on the right side of the road, and each of these lanes is associated with one set of sibling lanes at the head of each lane. The carriageway categorizer 210 may build a positional array of sibling-lane type IDs, e.g., an array of {2, 3, 4} representing sibling-lane type 2 for the lane-position 1, sibling-lane type 3 for the middle lane, and sibling-lane type 4 for the rightmost lane. This array may represent the carriageway category.

In some embodiments, the carriageway category identifiers or carriageway sibling-lane type numbering may be assigned based on relative frequency of different carriageway or lane arrangements. For example, after assigning initial categories to carriageways within the map database 100, the carriageway categorizer 210 may count the number of each of the carriageway categories. The carriageway categorizer 210 may create a new numbering scheme for the categories based on their relative frequency, e.g., so that category 1 describes the most common carriageway, category 2 describes the second most common carriageway, etc. In some embodiments, different numbering schemes may be used for inbound and outbound carriageways.

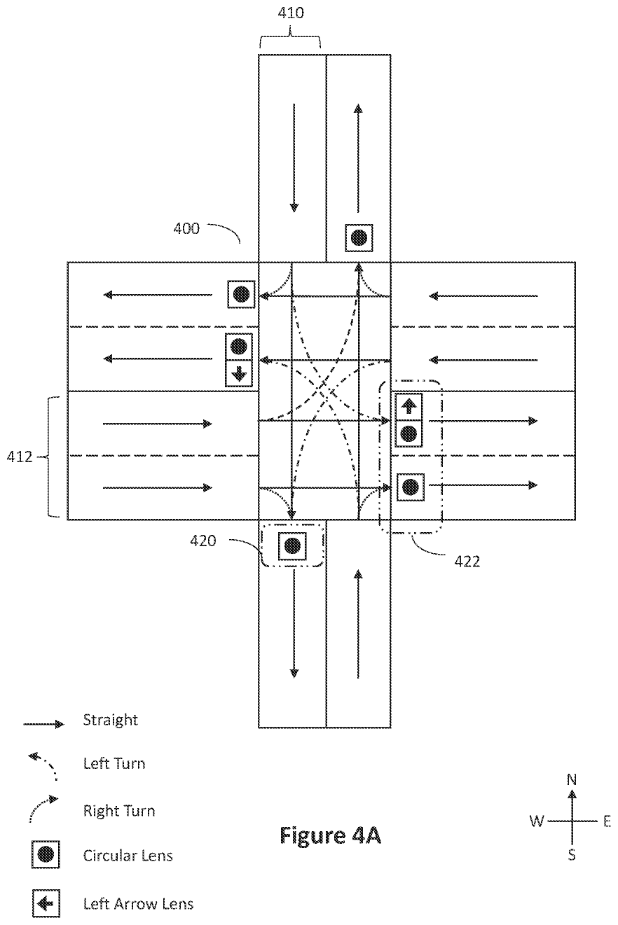

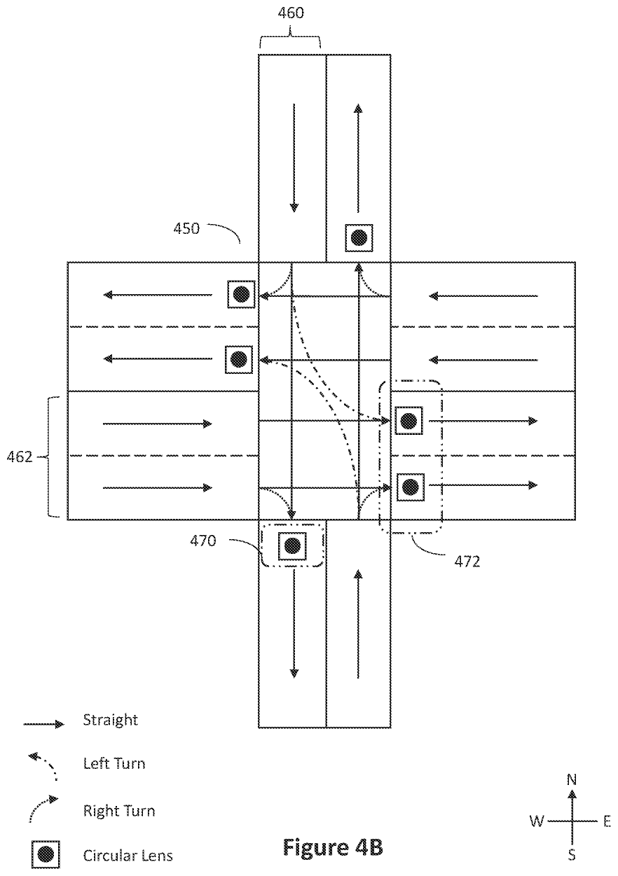

The TCSC categorizer 220 determines constellation categories for traffic lights, or more generally, for traffic control signals described by the traffic signal data 150. As used herein, a traffic control signal constellation (TCSCs) refers to a collection of traffic control signals that are erected in front of an inbound carriageway to control the flow of traffic through a road intersection from the specific carriageway. A TCSC, also referred to herein as a constellation, may be arrayed with different types of signal housings in a specific relative arrangement across the view of incoming traffic. For example, a constellation may contain a first traffic control signal near a left turn lane, where the first traffic control signal has left-arrow lenses; a second traffic control signal directly to the fore of the carriageway, where the second traffic control signal has circular lenses; and a third traffic control signal near a right turn lane, where the third traffic control signal has right-arrow lenses. The placement of the traffic control signals relative to the inbound carriageway and the styles of the signal lenses may be used to determine the category of the TCSC. FIGS. 4A and 4B, described further below, illustrate some example TCSCs.

Like the carriageway categories, different TCSC categories may be assigned different numbers, letters, or alphanumeric codes. The TCSC categorizer 220 may assign TCSC constellation categories based on relative frequency, e.g., the most common TCSC category may be assigned category A or 1, the second-most common TCSC category may be assigned category B or 2, etc. Alternatively, the TCSC categorizer 220 may build a positional array of traffic signal IDs, e.g., an array of {C, A, B} representing three types of traffic control signals arrayed from left to right across the view of incoming traffic. Note that TCSC categories are generally associated with inbound external carriageways, and TCSC categories may not be associated with outbound carriageways.

The lane QA system 230 receives carriageway categories from the carriageway categorizer 210 and processes the carriageway categories to determine whether there may be errors in the lane data 110. The lane QA system 230 may be programmed to check for one or more expected patterns in the carriageway categories. In some embodiments, the lane QA system 230 may automatically identify patterns in the carriageways categories in a given region (e.g., along a particular roadway, along a particular type of roadways, in a particular municipality, etc.), and check whether carriageway categories match the pattern. The lane QA system 230 may request human confirmation of a carriageway category, or human confirmation of lane data that lead to the assignment of the carriageway category by the carriageway categorizer 210. For example, the lane QA system 230 may provide data for carriageways or intersections that need data confirmation or correction to the map data UI 250, described below. The lane QA system 230 may update the lane data 110 based on human input in response to the confirmation request, e.g., by changing the lane data 110, or by marking that the lane QA system 230 has confirmed the existing lane data 110.

One example pattern that the lane QA system 230 may check is symmetry of carriageway categories around an intersection. In a four-way intersection, pairs of inbound carriageways that approach an intersection from diametrically opposing directions commonly have the same carriageway category, and discrepancies in categorization of such symmetrical pairs can indicate data flaws. Similarly, pairs of outbound carriageways that exit the intersection from diametrically opposing directions commonly have the same carriageway category, and discrepancies in categorization of such symmetrical pairs can indicate data flaws. This is also referred to as rotational symmetry. In a three-way or T intersection, the linearly opposing inbound and outbound carriageways commonly have carriageway types with reflection or mirror symmetry. The lane QA system 230 may identify variations from mirror symmetry for linearly opposing carriageways as potential data flaws.

As another example, pairs of inbound and outbound carriageways connected to an intersection have topological relations to each other through the intersection. The internal lanes which connect a pair of inbound carriageways and outbound carriageways have expected navigation maneuvers through the intersection, such as right-turn or left-turn maneuvers. The lane QA system 230 may use disparities in attribution of lane maneuver type between two such topologically connected carriageways to identify flaws in the lane data 110.

The traffic control QA system 240 receives TCSC categories from the TCSC categorizer 220 and processes the TCSC categories to determine whether there may be errors in the traffic signal data 150. The traffic control QA system 240 may be programmed to check for one or more expected patterns in the TCSC categories. In some embodiments, the traffic control QA system 240 may automatically identify patterns in the TCSC categories in a given region (e.g., along a particular roadway, along a particular type of roadways, in a particular municipality, etc.), and check whether TCSC categories match the pattern. The traffic control QA system 240 may request human confirmation of a TCSC category, or human confirmation of traffic control data that lead to the assignment of the TCSC category by the TCSC categorizer 220. For example, the traffic control QA system 240 may provide data for TCSCs or intersections that need data confirmation or correction to the map data UI 250, described below. The traffic control QA system 240 may update the traffic signal data 150 based on human input in response to the confirmation request, e.g., by changing the traffic signal data 150, or by marking that the traffic control QA system 240 has confirmed the existing traffic signal data 150.

One example pattern that the traffic control QA system 240 may check is symmetry of TCSC categories around an intersection. For example, for intersections of two orthogonally-connected roadways, it is common for the TCSC category to match between pairs of linearly opposing carriageways. The traffic control QA system 240 may use mismatches in the TCSC categories to detect potential flaws in the traffic signal data 150.

As another example, the traffic control QA system 240 may look at a TCSC category in conjunction with inbound lane data, e.g., an inbound carriageway category, and/or internal lane data 130. TCSC categories have expected relationships to the set of lanes in an inbound carriageway and the maneuvers through the intersection that can be made from the inbound carriageway. For example, a left-turn-only lane on the left side of a carriageway can be related to a traffic-signal to the left of the carriageway which may contain left-arrow lenses. The traffic control QA system 240 may identify mismatches between the TCSC category and the arrangement of lane turns for the inbound carriageway, which may indicate data flaws in either the traffic signal data 150 or the lane data 110.

The map data UI 250 generates user interfaces for human operators to review map data, such as lane data 110 and traffic signal data 150. As noted above, the lane QA system 230 and/or traffic control QA system 240 may identify deviations from patterns in the lane data 110 and/or the traffic signal data 150 based on the carriageway categories and/or TCSC categories. The map data UI 250 may receive data describing a discrepancy, e.g., the current lane data 110 and/or traffic signal data 150 for the intersection, and a location of the intersection. The map data UI 250 may output a request for a human to review the data and confirm whether or not the data is correct, and if the data is not correct, input one or more corrections to the data. In some embodiments, the map data UI 250 may retrieve one or more images of the intersection, such as an aerial view of the intersection, or one or more lower-angle views of the intersection, e.g., imagery received from an AV. For example, if the traffic control QA system 240 identifies a possible error in a TCSC, the map data UI 250 may retrieve one or more images of the TCSC, e.g., an image taken from the view of incoming traffic.

In some embodiments, the lane QA system 230 and/or traffic control QA system 240 may flag potentially erroneous data in the map database 100 prior to human review. AVs may avoid carriageways or intersections that have been flagged for review but not yet been confirmed. For example, if a particular intersection has been flagged as having potentially erroneous data, this may be reflected in the HD geospatial database 922, and the planning stack 916 of the AV 902 may determine a route for the AV 902 that avoids the intersection.

The map data generator 260 automatically generates certain types of map data based on existing map data and observed patterns in map data. For example, for a given intersection, the map data generator 260 may generate data describing the internal lanes based on external lane data 140, traffic control data 120, and/or captured images 170 for the intersection. The map data generator 260 may populate the internal lane data 130 to include the automatically generated data. As another example, the map data generator 260 may generate data describing traffic signals based on external lane data 140, internal lane data 130, and/or captured images 170 for the intersection. The map data generator 260 may populate the traffic signal data 150 to include the automatically generated data.

In some cases, the internal lanes may be deterministically determined from the external lane data and/or the TCSC. For example, if a single-lane inbound carriageway faces a TCSC that includes a left arrow, a right arrow, and a circular signal, the internal lanes extending from this carriageway include a left turn maneuver, straight maneuver, and right turn maneuver. In this case, the map data generator 260 may automatically generate the internal lane data 130 based on the TCSC and inbound carriageway data (e.g., external lane data indicating that the carriageway includes a single lane). In some embodiments, the map data generator 260 recognizes patterns based on existing data. For example, the map data generator 260 may process data describing multiple intersections within a given region and determine that, within this region, a particular carriageway category and particular TCSC category always have a particular associated set of internal lane types. The map data generator 260 may use this pattern to populate internal lanes for intersections for which the internal lane data is missing. As another example, the map data generator 260 may process data describing multiple intersections within a given region and determine that, within this region, a particular carriageway category always has a particular associated TCSC category. The map data generator 260 may use this pattern to populate traffic signal data 150 for intersections for which the traffic signal data 150 is missing.

To populate the internal lane data 130, the map data generator 260 may further calculate lane geometry for the internal lanes, e.g., the locations center lines and/or boundaries, based on data describing the lines of the intersection boundary and/or the locations of the external lanes as represented in the external lane data 140. In some embodiments, the map data generator 260 may determine the boundaries of the intersection based on one or more captured images 170.

### Example Intersections and Carriageways

FIGS. 3A-3B illustrate two example intersections 300 and 350. In FIG. 3A, the intersection 300 is a four-way intersection, with two orthogonally connected roads crossing at the intersection 300. Each road has two lanes 302 traveling in each direction. At the north side of the intersection in the orientation shown, the roadway is split into two carriageways 310 and 312. The carriageway 310 includes two lanes 302a and 302b traveling into the intersection 300, and the carriageway 312 includes two lanes 302c and 302d traveling out of the intersection 300. The carriageway 310 is referred to as an inbound carriageway, and the carriageway 312 is an outbound carriageway. Likewise, on the south side of the intersection, the carriageway 314 is an outbound carriageway that includes two lanes traveling out of the intersection 300, and the carriageway 316 is an inbound carriageway that includes two lanes traveling into the intersection 300. The direction of travel is indicated by the arrows within the lanes 302.

Within a carriageway with multiple lanes, position numbers may be assigned to each lane. For example, in a region with right-side-of-road driving rules, the leftmost lane in a carriageway may be assigned lane position 1. In the example carriageway 310 shown in FIG. 3A, lane 302b may be position 1, and lane 302a may be position 2. In the carriageway 312, lane 302c may be position 1, and lane 302d may be position 2.

A boundary of the intersection 300, i.e., the line between the external lanes and the internal lanes, is indicated with a thick dashed line. The internal lanes within the intersection 300 are represented as directed pathways through the intersection, where different types of maneuvers are represented with different types of lines, as provided in the legend. For example, the solid line 320 represents an internal lane that is a straight maneuver through the intersection 300. The physical shape of the lane represented by the solid line 320 is indicated by the shaded region around the solid line 320. As another example, the dashed line 322 represents an internal lane that is a left turn maneuver through the intersection 300. The physical shape of the lane represented by the dashed line 322 is indicated by the shaded region around the dashed line 322. Internal lanes for right turn maneuvers are represented by a different style of dashed line.

As discussed above, to determine the carriageway category for an inbound carriageway, such as carriageway 310, the carriageway categorizer 210 may identify, for each inbound lane in the inbound carriageway, all of the internal sibling lanes connected to the inbound lane. For lane 302b (i.e., lane position 1), the internal sibling lanes include a straight lane and a left turn lane. For lane 302a (i.e., lane position 2), the internal sibling lanes include a straight lane and a right turn lane. These two sets of inbound sibling lanes at their relative positions (position 1 and position 2) may be associated with a particular carriageway category, e.g., category 1.

To determine the carriageway category for an outbound carriageway, such as carriageway 312, the carriageway categorizer 210 may identify, for each outbound lane in the outbound carriageway, all of the internal sibling lanes connected to the outbound lane. For lane 302c (i.e., lane position 1), the internal sibling lanes include a straight lane and a left turn lane. For lane 302d (i.e., lane position 2), the internal sibling lanes include a straight lane and a right turn lane. These two sets of outbound sibling lanes at their relative positions (position 1 and position 2) may be associated with a particular carriageway category, e.g., category 2.

In the example shown in FIG. 3A, all four of the inbound carriageways have the same category (e.g., category 1), and all four of the outbound carriageways have the same category (e.g., category 2). The intersection 300 exhibits rotational symmetry at both 90° and 180° rotations. For example, the carriageway 310 has the same category as the carriageway 316, which is 180° from the carriageway 310.

In the example shown in FIG. 3B, the intersection 350 is a four-way intersection, with two orthogonally connected roads crossing at the intersection 350. A first road that travels cast-west in the orientation shown has two lanes traveling in each direction, while a second road that travels north-south in the orientation shown has one lane traveling in each direction. This second roadway is split into two carriageways 360 and 362, where each carriageway 360 and 362 includes a single lane. The inbound carriageway 360 has three internal sibling lanes connected to the carriageway 360 and extending through the intersection 350: a right turn lane, a straight lane, and a left turn lane. The outbound carriageway 362 has three internal sibling lanes connected to the carriageway 362: a right turn lane, a straight lane, and a left turn lane.

Compared to the intersection 300 in FIG. 3A, changing the north-south road from a four-lane road to a two-lane road changes the carriageway type and, therefore, the carriageway category of the carriageways, e.g., the carriageway categories for carriageways 360 and 362 are different from the carriageway categories for the carriageways 310 and 312. The carriageway categories for the east-west carriageways in FIG. 3B are the same as the carriageway categories for the east-west carriageways in FIG. 3A. The geometry of the internal lanes representing left turns through the intersection 350 have changed relative to FIG. 3A, because the intersection 350 has a rectangular boundary rather than a square boundary. Furthermore, the intersection 350 exhibits rotational symmetry at a 180° rotation, but not at a 90° rotation.

### Example Traffic Control Signal Constellations

FIGS. 4A and 4B illustrate two example sets of traffic control signals at an example intersection, according to some examples of the present disclosure. Intersection 400 in FIG. 4A is similar to the intersection 350 in FIG. 3B, described above. FIG. 4A further illustrates a set of traffic control signals at the intersection 400. The traffic control signals include lights with circular lenses and lights with left arrow lenses, as indicated in the legend. The traffic control signals are arranged in constellations, or TCSCs, as described above. For example, the constellation 420 includes a single traffic signal with a circular lens. The constellation 420 controls traffic from the carriageway 410, which faces the constellation 420. The constellation 422 includes, at a left position, a pair of traffic signals, where the pair includes a signal with a left arrow lens and a signal with a circular lens. The constellation 422 further includes, at a right position, one traffic signal with a circular lens. The constellation 422 controls traffic from the carriageway 412, which faces the constellation 422. In this example, the pair of traffic signals at the left position control traffic from lane position 1 (i.e., the left lane) in the carriageway 412, while the single traffic signal at the right position controls traffic from lane position 2 (i.e., the right lane) in the carriageway 412.

FIG. 4B illustrates a second example intersection 450. The intersection 450 has a similar geometry to the intersection 400, but the intersection 450 does not allow left turns from along the east-west roadway. In this example, the traffic control signals only include lights with circular lenses. While the intersection 400 provides protected left turns from the carriageway 412, the intersection 400 does not allow left turns from the carriageway 462, and the constellation 472 does not include the left arrow signal. Thus, the maneuvers through the intersection 450 represented by internal lanes through the intersection 450 agree with the TCSCs at the intersection 450. In this example, unprotected left turns are permitted from the north-south roadway; e.g., an unprotected left turn may be made from the carriageway 460. If the traffic signal data 150 indicated that the constellation 472 included a traffic signal with a left arrow lens, but the carriageway category determined by the carriageway categorizer 210, or the lane data 110, did not include a left-turn lane or maneuver through the intersection 450, this may indicate a data error either in the traffic signal data 150 or the lane data 110.

### Example Roadways with Multiple Intersections

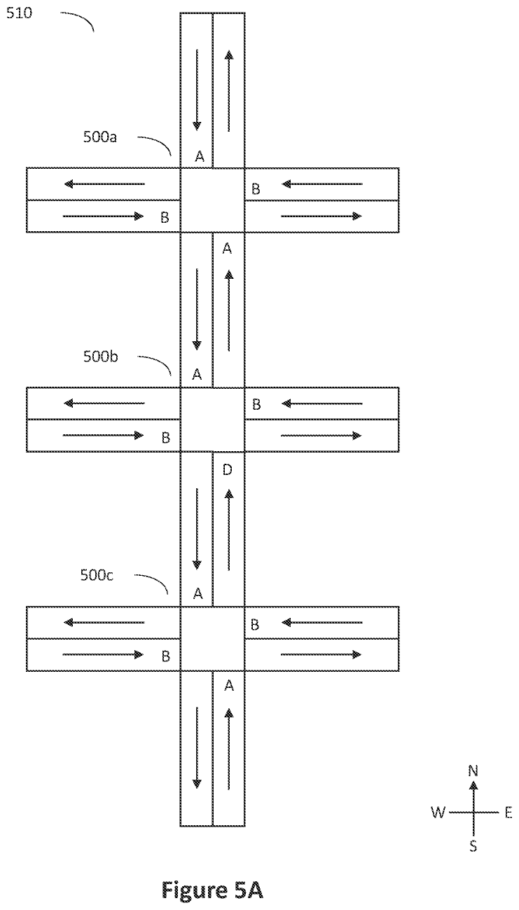

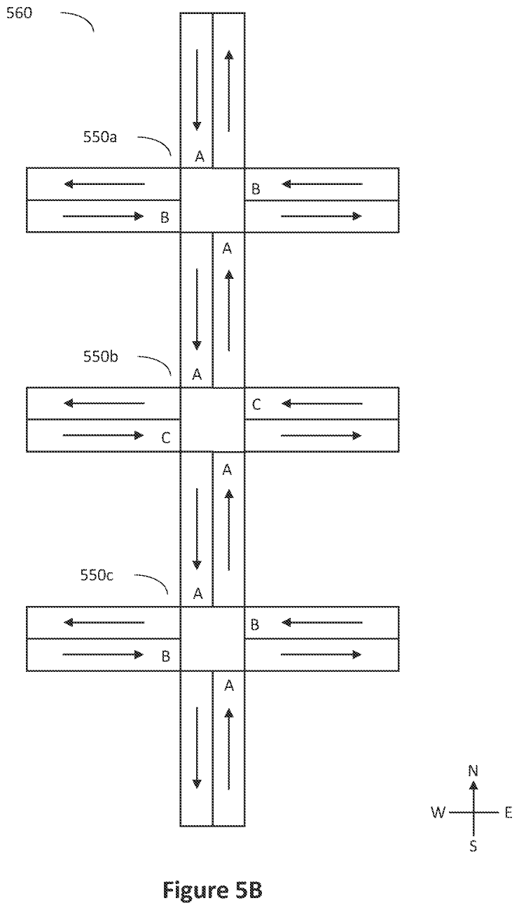

FIG. 5A illustrates an example of three intersections 500a, 500b, and 500c along a roadway 510, according to some examples of the present disclosure. The carriageway categories for each of the inbound carriageways illustrated in FIG. 5 are labeled with letters A, B, and D, where A refers to one carriageway category (e.g., the most frequent carriageway category), B refers to another carriageway category (e.g., the second-most frequent carriageway category), and D refers to another carriageway category (e.g., the fourth-most frequent carriageway category). In this case, all of the inbound carriageways traveling in the cast or west direction are category B, and most of the inbound carriageways traveling in the north or south direction are category A. The carriageway traveling north into the intersection 500b is labeled carriageway category D. The lane QA system 230 may determine that the usual pattern for this roadway 510 is carriageway category A in the north-south direction, and carriageway category D on the north-bound carriageway at the intersection 500b may reflect an error in the lane data 110.

FIG. 5B illustrates a second example of three intersections 550a, 550b, and 550c along a roadway 560, according to some examples of the present disclosure. The carriageway categories for each of the inbound carriageways illustrated in FIG. 5 are labeled with letters A, B, and C. In this case, the inbound carriageways traveling in the east or west direction to intersections 550a and 550c are category B, while the inbound carriageways traveling in the east or west direction to intersection 550b are category C. The lane QA system 230 may determine that the usual pattern for this roadway 560 is carriageway category B for roads intersecting the roadway 560, and carriageway category C on the carriageways intersecting the road 560 at the intersection 550b may reflect an error in the lane data 110. However, unlike the potentially erroneous carriageway category D in FIG. 5A, in this example, both the east and the west carriageways into intersection 550b are category C, and this intersection 550b displays rotational symmetry. This may indicate that the category C is a likely variation to the normal pattern, rather than reflecting a data error. Thus, the lane QA system 230 may not identify the carriageway categories C as reflecting an error at the intersection 550b.

### Example Process for Generating Map Data

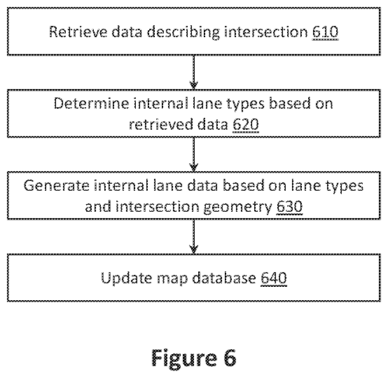

FIG. 6 illustrates an example process for adding internal lane data to a map database, according to some examples of the present disclosure. The map data review system 200 retrieves 610 data describing an intersection, e.g., from the map database 100. For example, the map data review system 200 retrieves external lane data 140 and/or traffic signal data 150 for a particular intersection. The map data review system 200 determines 620 internal lanes for the intersection based on the retrieved data. For example, the map data review system 200 uses programmed or automatically detected patterns for traffic light constellations and external lanes to determine number and types of internal lane through the intersection.

The map data review system 200 (e.g., the map data generator 260) generates 630 internal lane data based on the determined internal lanes and the intersection geometry. For example, the map data review system 200 may automatically generate the geometry for the path for each of the determined internal lanes through the intersection based on the end points of the external lanes, the geometry of the intersection boundary, physical features such as painted lines or medians detected in one or captured images 170 of the intersection, or other data describing the intersection. The generated internal lane data may further include a direction of travel, a maneuver type (e.g., straight, left turn, right turn, or U-turn), a speed limit (e.g., based on speed limit of the roadways leading into the intersection), or other data.

The map data review system 200 updates 640 the map database 100 to include the generated internal lane data. For example, the map data review system 200 populates the internal lane data 130 of the map database 100 to include the generated internal lane data. In some embodiments, the automatically generated internal lane data may be provided to a human for human review, e.g., using the map data UI 250.

### Example Process for Updating Map Data

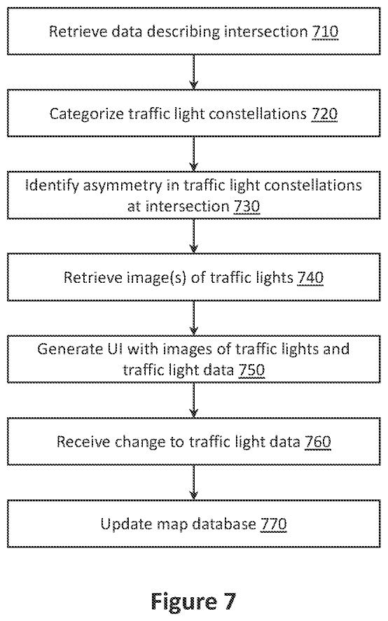

FIG. 7 illustrates an example process for updating a map database with correct traffic light data, according to some examples of the present disclosure. The map data review system 200 retrieves 710 data describing an intersection, e.g., from the map database 100. For example, the map data review system 200 retrieves lane data 110 and/or traffic signal data 150 for a particular intersection.

The map data review system 200 categorizes 720 traffic light constellations in the intersection. For example, the TCSC categorizer 220 determines a category for each constellation of traffic lights at the intersection. The map data review system 200 identifies 730 an asymmetry in the traffic light constellations at the intersection. For example, if the intersection is a four-way intersection, the traffic control QA system 240 determines whether the traffic light constellations exhibit rotational symmetry (e.g., 180° rotational symmetry). As another example, if the intersection is a three-way T intersection, the traffic control QA system 240 determines whether the traffic light constellations exhibit mirror symmetry. In other embodiments, the map data review system 200 may search for potential data anomalies using other patterns, e.g., by examining multiple traffic light constellations along a roadway, and determining if a traffic light constellation deviates from a pattern observed along the roadway.

In response to identifying an asymmetry, the map data review system 200 retrieves 740 an image of the traffic lights. For example, the map data UI 250 retrieves one or more camera images, LIDAR point cloud, or other images or visualizations of the traffic lights from the captured images 170. The map data review system 200 (e.g., the map data UI 250) generates 750 a user interface including the retrieved image or images of the traffic lights, along with traffic light data. For example, the map data UI 250 may generate an image of the traffic lights with a human-readable categorization of each of the traffic lights overlaid on the image, e.g., on or near each of the traffic lights.

The map data UI 250 may enable a user to provide user input indicating whether the categorization of the traffic lights is correct, e.g., a pair of buttons for each traffic light that allow the user to select “correct” or “incorrect.” As another example, the user may select a categorization that is incorrect, or select a “next” or “correct” button if all of the categorizations are correct. If any of the traffic light data is incorrect, the map data review system 200 (e.g., the map data UI 250) receives 760 a change to the traffic light data. For example, the user may provide an input that indicates corrected traffic light data, e.g., an input indicating that a particular traffic control is associated with a different inbound lane, or an input indicating that a particular traffic control is a different type (e.g., an arrow lens rather than a circular lens). The map data review system 200 (e.g., the traffic control QA system 240) updates 770 the map database 100 to reflect the change to the traffic light data provided by the user.

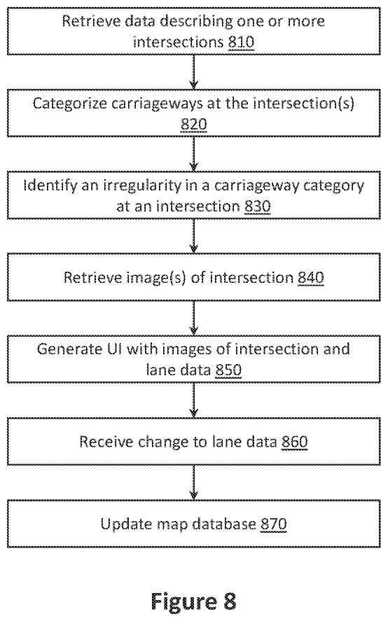

FIG. 8 illustrates an example process for updating a map database with correct lane data, according to some examples of the present disclosure. The map data review system 200 retrieves 810 data describing one or more intersections, e.g., from the map database 100. For example, the map data review system 200 retrieves lane data 110 and/or traffic signal data 150 for a particular intersection, or a set of intersections along a roadway.

The map data review system 200 categorizes 820 carriageways at the intersection or intersections. For example, the carriageway categorizer 210 determines a category for each inbound carriageway and/or outbound carriageway at a particular intersection. The map data review system 200 identifies 830 an irregularity in a carriageway category at an intersection. For example, if the intersection is a four-way intersection, the lane QA system 230 determines whether the inbound carriageways around the intersection exhibit rotational symmetry (e.g., 180° rotational symmetry). As another example, the lane QA system 230 determines whether the inbound carriageways into a given intersection properly correspond to the outbound carriageways from the intersection. In some embodiments, the lane QA system 230 further considers traffic light data, e.g., whether an inbound carriageway category is a suitable match for a TCSC constellation controlling the flow of traffic from the inbound carriageway.

In response to identifying an irregularity (e.g., an asymmetry, a pattern mismatch, an inbound/outbound mismatch, or a carriageway/TCSC mismatch), the map data review system 200 retrieves 840 an image of the intersection. For example, the map data UI 250 retrieves one or more camera images, LIDAR point cloud, or other images or visualizations of the intersection from the captured images 170. The map data review system 200 (e.g., the map data UI 250) generates 850 a user interface including the retrieved image or images of the intersection, along with lane data. For example, the map data UI 250 may generate an image of the external and/or internal lanes or carriageways with a human-readable categorization of each of the lanes or carriageways overlaid on the image, e.g., on or near each of the lanes.

The map data UI 250 may enable a user to provide user input indicating whether the categorization of the carriageways or lanes is correct, e.g., a pair of buttons for each carriageway that allow the user to select “correct” or “incorrect.” As another example, the user may select a categorization that is incorrect, or select a “next” or “correct” button if all of the categorizations are correct. If any of the lane data is incorrect, the map data review system 200 (e.g., the map data UI 250) receives 860 a change to the lane data. For example, the user may provide an input that indicates corrected lane data, e.g., an input changing possible maneuvers from the lanes, an input removing or adding lanes or pathways, etc. The map data review system 200 (e.g., the lane QA system 230) updates 870 the map database 100 to reflect the change to the lane data provided by the user.

### Example AV and AV Management System

Turning now to FIG. 9, this figure illustrates an example of an AV management system 900. One of ordinary skill in the art will understand that, for the AV management system 900 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 900 includes an AV 902, a data center 950, and a client computing device 970. The AV 902, the data center 950, and the client computing device 970 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 902 may navigate about roadways without a human driver based on sensor signals generated by multiple sensor systems 904, 906, and 908. The sensor systems 904-908 may include different types of sensors and may be arranged about the AV 902. For instance, the sensor systems 904-908 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., GPS receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 904 may be a camera system, the sensor system 906 may be a LIDAR system, and the sensor system 908 may be a RADAR system. Other embodiments may include any other number and type of sensors.

AV 902 may also include several mechanical systems that may be used to maneuver or operate AV 902. For instance, the mechanical systems may include vehicle propulsion system 930, braking system 932, steering system 934, safety system 936, and cabin system 938, among other systems. Vehicle propulsion system 930 may include an electric motor, an internal combustion engine, or both. The braking system 932 may include an engine brake, a wheel braking system (e.g., a disc braking system that utilizes brake pads), hydraulics, actuators, and/or any other suitable componentry configured to assist in decelerating AV 902. The steering system 934 may include suitable componentry configured to control the direction of movement of the AV 902 during navigation. Safety system 936 may include lights and signal indicators, a parking brake, airbags, and so forth. The cabin system 938 may include cabin temperature control systems, in-cabin entertainment systems, and so forth. In some embodiments, the AV 902 may not include human driver actuators (e.g., steering wheel, handbrake, foot brake pedal, foot accelerator pedal, turn signal lever, window wipers, etc.) for controlling the AV 902. Instead, the cabin system 938 may include one or more client interfaces (e.g., Graphical User Interfaces (GUIs), Voice User Interfaces (VUIs), etc.) for controlling certain aspects of the mechanical systems 930-938.

AV 902 may additionally include a local computing device 910 that is in communication with the sensor systems 904-908, the mechanical systems 930-938, the data center 950, and the client computing device 970, among other systems. The local computing device 910 may include one or more processors and memory, including instructions that may be executed by the one or more processors. The instructions may make up one or more software stacks or components responsible for controlling the AV 902; communicating with the data center 950, the client computing device 970, and other systems; receiving inputs from riders, passengers, and other entities within the AV's environment; logging metrics collected by the sensor systems 904-908; and so forth. In this example, the local computing device 910 includes a perception stack 912, a mapping and localization stack 914, a planning stack 916, a control stack 918, a communications stack 920, a HD geospatial database 922, and an AV operational database 924, among other stacks and systems.

Perception stack 912 may enable the AV 902 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 904-908, the mapping and localization stack 914, the HD geospatial database 922, other components of the AV, and other data sources (e.g., the data center 950, the client computing device 970, third-party data sources, etc.). The perception stack 912 may detect and classify objects and determine their current and predicted locations, speeds, directions, and the like. In addition, the perception stack 912 may determine the free space around the AV 902 (e.g., to maintain a safe distance from other objects, change lanes, park the AV, etc.). The perception stack 912 may also identify environmental uncertainties, such as where to look for moving objects, flag areas that may be obscured or blocked from view, and so forth.

Mapping and localization stack 914 may determine the AV's position and orientation (pose) using different methods from multiple systems (e.g., GPS, IMUs, cameras, LIDAR, RADAR, ultrasonic sensors, the HD geospatial database 922, etc.). For example, in some embodiments, the AV 902 may compare sensor data captured in real-time by the sensor systems 904-908 to data in the HD geospatial database 922 to determine its precise (e.g., accurate to the order of a few centimeters or less) position and orientation. The AV 902 may focus its search based on sensor data from one or more first sensor systems (e.g., GPS) by matching sensor data from one or more second sensor systems (e.g., LIDAR). If the mapping and localization information from one system is unavailable, the AV 902 may use mapping and localization information from a redundant system and/or from remote data sources.

The planning stack 916 may determine how to maneuver or operate the AV 902 safely and efficiently in its environment. For example, the planning stack 916 may receive the location, speed, and direction of the AV 902, geospatial data, data regarding objects sharing the road with the AV 902 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 902 from one point to another. The planning stack 916 may determine multiple sets of one or more mechanical operations that the AV 902 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 916 may select from multiple backup plans to carry out. For example, while preparing to change lanes to turn right at an intersection, another vehicle may aggressively cut into the destination lane, making the lane change unsafe. The planning stack 916 could have already determined an alternative plan for such an event, and upon its occurrence, help to direct the AV 902 to go around the block instead of blocking a current lane while waiting for an opening to change lanes.

The control stack 918 may manage the operation of the vehicle propulsion system 930, the braking system 932, the steering system 934, the safety system 936, and the cabin system 938. The control stack 918 may receive sensor signals from the sensor systems 904-908 as well as communicate with other stacks or components of the local computing device 910 or a remote system (e.g., the data center 950) to effectuate operation of the AV 902. For example, the control stack 918 may implement the final path or actions from the multiple paths or actions provided by the planning stack 916. Implementation may involve turning the routes and decisions from the planning stack 916 into commands for the actuators that control the AV's steering, throttle, brake, and drive unit.

The communication stack 920 may transmit and receive signals between the various stacks and other components of the AV 902 and between the AV 902, the data center 950, the client computing device 970, and other remote systems. The communication stack 920 may enable the local computing device 910 to exchange information remotely over a network, such as through an antenna array or interface that may provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 920 may also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), BLUETOOTH®, infrared, etc.).

The HD geospatial database 922 may store HD maps and related data of the streets upon which the AV 902 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer may include geospatial information of traffic signal lights, traffic signs, and other road objects and related attributes.

The AV operational database 924 may store raw AV data generated by the sensor systems 904-908 and other components of the AV 902 and/or data received by the AV 902 from remote systems (e.g., the data center 950, the client computing device 970, etc.). In some embodiments, the raw AV data may include HD LIDAR point cloud data, image or video data, RADAR data, GPS data, and other sensor data that the data center 950 may use for creating or updating AV geospatial data as discussed further below and elsewhere in the present disclosure.

The data center 950 may be a private cloud (e.g., an enterprise network, a co-location provider network, etc.), a public cloud (e.g., an laaS network, a PaaS network, a SaaS network, or other CSP network), a hybrid cloud, a multi-cloud, and so forth. The data center 950 may include one or more computing devices remote to the local computing device 910 for managing a fleet of AVs and AV-related services. For example, in addition to managing the AV 902, the data center 950 may also support a ridesharing service, a delivery service, a remote/roadside assistance service, street services (e.g., street mapping, street patrol, street cleaning, street metering, parking reservation, etc.), and the like.

The data center 950 may send and receive various signals to and from the AV 902 and the client computing device 970. These signals may include sensor data captured by the sensor systems 904-908, roadside assistance requests, software updates, ridesharing pick-up and drop-off instructions, and so forth. In this example, the data center 950 includes one or more of a data management platform 952, an Artificial Intelligence/Machine Learning (AI/ML) platform 954, a simulation platform 956, a remote assistance platform 958, a ridesharing platform 960, and a map management platform 962, among other systems.

Data management platform 952 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 950 may access data stored by the data management platform 952 to provide their respective services.

The AI/ML platform 954 may provide the infrastructure for training and evaluating machine learning algorithms for operating the AV 902, the simulation platform 956, the remote assistance platform 958, the ridesharing platform 960, the map management platform 962, and other platforms and systems. Using the AI/ML platform 954, data scientists may prepare data sets from the data management platform 952; select, design, and train machine learning models; evaluate, refine, and deploy the models; maintain, monitor, and retrain the models; and so on.

The simulation platform 956 may enable testing and validation of the algorithms, machine learning models, neural networks, and other development efforts for the AV 902, the remote assistance platform 958, the ridesharing platform 960, the map management platform 962, and other platforms and systems. The simulation platform 956 may replicate a variety of driving environments and/or reproduce real-world scenarios from data captured by the AV 902, including rendering geospatial information and road infrastructure (e.g., streets, lanes, crosswalks, traffic lights, stop signs, etc.) obtained from the map management platform 962; modeling the behavior of other vehicles, bicycles, pedestrians, and other dynamic elements; simulating inclement weather conditions, different traffic scenarios; and so on.

The remote assistance platform 958 may generate and transmit instructions regarding the operation of the AV 902. For example, in response to an output of the AI/ML platform 954 or other system of the data center 950, the remote assistance platform 958 may prepare instructions for one or more stacks or other components of the AV 902.

The ridesharing platform 960 may interact with a customer of a ridesharing service via a ridesharing application 972 executing on the client computing device 970. The client computing device 970 may be any type of computing system, including a server, desktop computer, laptop, tablet, smartphone, smart wearable device (e.g., smart watch; smart eyeglasses or other Head-Mounted Display (HMD); smart ear pods or other smart in-car, on-ear, or over-ear device; etc.), gaming system, or other general-purpose computing device for accessing the ridesharing application 972. The client computing device 970 may be a customer's mobile computing device or a computing device integrated with the AV 902 (e.g., the local computing device 910). The ridesharing platform 960 may receive requests to be picked up or dropped off from the ridesharing application 972 and dispatch the AV 902 for the trip.

Map management platform 962 may provide a set of tools for the manipulation and management of geographic and spatial (geospatial) and related attribute data. The data management platform 952 may receive LIDAR point cloud data, image data (e.g., still image, video, etc.), RADAR data, GPS data, and other sensor data (e.g., raw data) from one or more AVs 902, Unmanned Aerial Vehicles (UAVs), satellites, third-party mapping services, and other sources of geospatially referenced data. The raw data may be processed, and map management platform 962 may render base representations (e.g., tiles (2D), bounding volumes (3D), etc.) of the AV geospatial data to enable users to view, query, label, edit, and otherwise interact with the data. Map management platform 962 may manage workflows and tasks for operating on the AV geospatial data. Map management platform 962 may control access to the AV geospatial data, including granting or limiting access to the AV geospatial data based on user-based, role-based, group-based, task-based, and other attribute-based access control mechanisms. Map management platform 962 may provide version control for the AV geospatial data, such as to track specific changes that (human or machine) map editors have made to the data and to revert changes when necessary. Map management platform 962 may administer release management of the AV geospatial data, including distributing suitable iterations of the data to different users, computing devices, AVs, and other consumers of HD maps. Map management platform 962 may provide analytics regarding the AV geospatial data and related data, such as to generate insights relating to the throughput and quality of mapping tasks.

In some embodiments, the map viewing services of map management platform 962 may be modularized and deployed as part of one or more of the platforms and systems of the data center 950. For example, the AI/ML platform 954 may incorporate the map viewing services for visualizing the effectiveness of various object detection or object classification models, the simulation platform 956 may incorporate the map viewing services for recreating and visualizing certain driving scenarios, the remote assistance platform 958 may incorporate the map viewing services for replaying traffic incidents to facilitate and coordinate aid, the ridesharing platform 960 may incorporate the map viewing services into the client application 972 to enable passengers to view the AV 902 in transit en route to a pick-up or drop-off location, and so on.

### Example Processor-Based Computer System

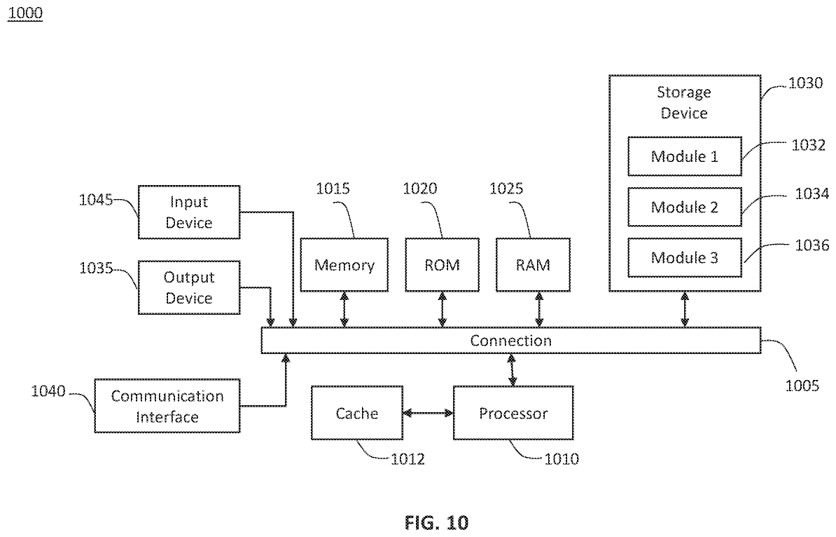

FIG. 10 illustrates an example processor-based system with which some aspects of the subject technology may be implemented. For example, processor-based system 1000 may be any computing device making up, or any component thereof in which the components of the system are in communication with each other using connection 1005. Connection 1005 may be a physical connection via a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1000 includes at least one processing unit (CPU or processor) 1010 and connection 1005 that couples various system components including system memory 1015, such as Read-Only Memory (ROM) 1020 and Random-Access Memory (RAM) 1025 to processor 1010. Computing system 1000 may include a cache of high-speed memory 1012 connected directly with, in close proximity to, or integrated as part of processor 1010.

Processor 1010 may include any general-purpose processor and a hardware service or software service, such as services 1032, 1034, and 1036 stored in storage device 1030, configured to control processor 1010 as well as a special purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms known to those of skill in the art. In some instances, multimodal systems may enable a user to provide multiple types of input/output to communicate with computing system 1000. Computing system 1000 may include communications interface 1040, which may generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1040 may also include one or more GNSS receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer-readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), ROM, Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1030 may include software services, servers, services, etc., that when the code that defines such software is executed by the processor 1010, it causes the system 1000 to perform a function. In some embodiments, a hardware service that performs a particular function may include the software component stored in a computer-readable medium in connection with the necessary hardware components, such as processor 1010, connection 1005, output device 1035, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 provides a computer implemented method for generating map data, the method including receiving data related to an intersection along a roadway, the data including: boundary data describing a boundary around the intersection, external lane data describing a set of external lanes outside the boundary of the intersection, and traffic control data describing a set of traffic controls positioned around the intersection; selecting a set of internal lane types for a corresponding set of internal lanes of the intersection based on the external lane data and the traffic control data; generating internal lane data describing the set of internal lanes, the internal lane data further based on the boundary data; and updating a map database to include the internal lane data.

Example 2 provides the method of Example 1, further including transmitting at least a portion of data in the updated map database to an AV; and autonomously routing the AV through the intersection based on the internal lane data.

Example 3 provides the method of Example 1, where generating the internal lane data for an internal lane includes generating lane geometry data based on the boundary data, the lane geometry data including a lane boundary or a center line for the internal lane.

Example 4 provides the method of Example 1, where the internal lane data includes a plurality of pathways through the intersection, each pathway of the plurality of pathways having a respective entrance point and exit point along the boundary around the intersection, and each pathway of the plurality of pathways having a respective direction of travel.

Example 5 provides the method of Example 1, further including retrieving an image of the intersection; generating, in a user interface, a display including the image of the intersection and a representation of the internal lane data; and receiving, via the user interface, a confirmation from a user that the representation of the internal lane data is correct.

Example 6 provides the method of Example 1, further including retrieving an image of the intersection; generating, in a user interface, a display including the image of the intersection and a representation of the internal lane data; receiving, via the user interface, a change to the internal lane data; and updating the map database based on the received change to the internal lane data.

Example 7 provides the method of Example 1, where the intersection is a first intersection, the method further including identifying a second intersection having: second external lane data matching at least a portion of the external lane data of the first intersection, and second traffic control data matching at least a portion of the traffic control data of the first intersection; retrieving second internal lane data associated with the second intersection; and generating the internal lane data further based on the second internal lane data.

Example 8 provides a non-transitory computer-readable medium storing instructions that, when executed by a processor, cause the processor to receive data related to an intersection along a roadway, the data including: boundary data describing a boundary around the intersection, external lane data describing a set of external lanes outside the boundary of the intersection, and traffic control data describing a set of traffic controls positioned around the intersection; select a set of internal lane types for a corresponding set of internal lanes of the intersection based on the external lane data and the traffic control data; generate internal lane data describing the set of internal lanes, the internal lane data further based on the boundary data; and update a map database to include the internal lane data.

Example 9 provides the computer-readable medium of Example 8, the instructions further causing the processor to transmit at least a portion of data in the updated map database to an AV; where the AV autonomously drives through the intersection based on the internal lane data.

Example 10 provides the computer-readable medium of Example 8, where generating the internal lane data for an internal lane includes generating lane geometry data based on the boundary data, the lane geometry data including a lane boundary or a center line for the internal lane.

Example 11 provides the computer-readable medium of Example 8, where the internal lane data includes a plurality of pathways through the intersection, each pathway of the plurality of pathways having a respective entrance point and exit point along the boundary around the intersection, and each pathway of the plurality of pathways having a respective direction of travel.

Example 12 provides the computer-readable medium of Example 8, the instructions further causing the processor to retrieve an image of the intersection; generate, in a user interface, a display including the image of the intersection and a representation of the internal lane data; and receive, via the user interface, a confirmation from a user that the representation of the internal lane data is correct.

Example 13 provides the computer-readable medium of Example 8, the instructions further causing the processor to retrieve an image of the intersection; generate, in a user interface, a display including the image of the intersection and a representation of the internal lane data; receive, via the user interface, a change to the internal lane data; and update the map database based on the received change to the internal lane data.

Example 14 provides the computer-readable medium of Example 8, where the intersection is a first intersection, the instructions further causing the processor to identify a second intersection having: second external lane data matching at least a portion of the external lane data of the first intersection, and second traffic control data matching at least a portion of the traffic control data of the first intersection; retrieve second internal lane data associated with the second intersection; and generate the internal lane data further based on the second internal lane data.

Example 15 provides a system including a map database storing data related to an intersection along a roadway, the data including: boundary data describing a boundary around the intersection, external lane data describing a set of external lanes outside the boundary of the intersection, and traffic control data describing a set of traffic controls positioned around the intersection; and a processor to select a set of internal lane types for a corresponding set of internal lanes of the intersection based on the external lane data and the traffic control data, generate internal lane data describing the set of internal lanes, the internal lane data further based on the boundary data, and update a map database to include the internal lane data.

Example 16 provides the system of Example 15, the processor further to transmit at least a portion of data in the updated map database to an AV, where the AV autonomously drives through the intersection based on the internal lane data.

Example 17 provides the system of Example 15, where generating the internal lane data for an internal lane includes generating lane geometry data based on the boundary data, the lane geometry data including a lane boundary or a center line for the internal lane.

Example 18 provides the system of Example 15, where the internal lane data includes a plurality of pathways through the intersection, each pathway of the plurality of pathways having a respective entrance point and exit point along the boundary around the intersection, and each pathway of the plurality of pathways having a respective direction of travel.

Example 19 provides the system of Example 15, the processor further to retrieve an image of the intersection; generate, in a user interface, a display including the image of the intersection and a representation of the internal lane data; and receive, via the user interface, a confirmation from a user that the representation of the internal lane data is correct.

Example 20 provides the system of Example 15, the processor further to retrieve an image of the intersection; generate, in a user interface, a display including the image of the intersection and a representation of the internal lane data; receive, via the user interface, a change to the internal lane data; and update the map database based on the received change to the internal lane data.

Example 21 provides a method for updating map data, the method including retrieving data from a map database related to an intersection along a roadway, the data including: boundary data describing a boundary around the intersection, external lane data describing a set of external lanes outside the boundary of the intersection, the set of external lanes arranged in a set of inbound carriageways that are inbound to the intersection and a set of outbound carriageways that are outbound from the intersection, and traffic light data describing a set of traffic lights arranged as traffic light constellations, each traffic light constellation associated with a respective inbound carriageway; for each of the traffic light constellations, identifying traffic light constellation categories based on the traffic light data; determining that a first traffic light constellation has a different traffic light constellation category from a second traffic light constellation, where a first inbound carriageway associated with the first traffic light constellation is opposite a second inbound carriageway associated with the second traffic light constellation; retrieving an image of the intersection; generating, in a user interface, a display including the image of the intersection and data describing the first traffic light constellation and the second traffic light constellation; receiving, via the user interface, a change to the data describing the one of the first traffic light constellation and the second traffic light constellation; and updating the map database based on the received change to the data.

Example 22 provides the method of Example 21, further including transmitting at least a portion of data in the updated map database to an AV; and autonomously driving the AV through the intersection based on the portion of the updated map.

Example 23 provides the method of Example 21, further including prior to receiving the change to the data, marking the intersection as unrouteable in the map database; transmitting at least a portion of data in the map database to an AV, the portion of data including data indicating that the intersection is unrouteable; determining a route for the AV, the route avoiding the intersection; and autonomously driving the AV through the route avoiding the intersection.

Example 24 provides a method for updating map data, the method including identifying a plurality of intersections along a roadway, each of the intersections including: a boundary around the intersection, a set of internal lanes inside the boundary of the intersection, and a set of external lanes outside the boundary of the intersection, the set of external lanes arranged in a set of carriageways; for each of the plurality of intersections, identifying a plurality of carriageway categories based on data describing the set of external lanes, each of the carriageway categories applying to a particular carriageway position; determining that, for a particular carriageway position, a first intersection of the plurality of intersections has a different carriageway category from a corresponding carriageway position of a second intersection of the plurality of intersections; retrieving an image of the first intersection; generating, in a user interface, a display including the image of the first intersection and data describing the external lanes of the carriageway at the particular carriageway position; receiving, via the user interface, a change to the data describing the external lanes of the carriageway; and updating a map database based on the received change to the data.

Example 25 provides the method of Example 24, further including transmitting at least a portion of data in the updated map database to an AV, the portion of data including the data describing the external lanes of the carriageway; and autonomously driving the AV through the first intersection based on the portion of the updated map.

Example 26 provides the method of Example 24, further including prior to receiving the change to the data, marking the first intersection as unrouteable in the map database; transmitting at least a portion of data in the map database to an AV, the portion of data including data indicating that the first intersection is unrouteable; determining a route for the AV, the route avoiding the first intersection; and autonomously driving the AV through the route avoiding the first intersection.

Example 27 provides a method for generating map data, the method including identifying an intersection along a roadway, the intersection including: a boundary around the intersection, and a set of external lanes outside the boundary of the intersection, the set of external lanes arranged in a set of carriageways, each carriageway having a respective position around the intersection; determining a carriageway category for each of the set of carriageways based on data describing the set of external lanes; generating data describing a set of internal lanes inside the boundary of the intersection based on the carriageway category for each of the set of carriageways; and updating a map database to include the data describing the set of internal lanes.

Example 28 provides the method of Example 27, the method further including transmitting at least a portion of the updated map to an AV, the portion including the intersection; and autonomously driving the AV through the intersection based on the portion of the updated map.

Example 29 includes an apparatus comprising means for performing the method of any of the Examples 1-7 or Examples 21-28.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer implemented method for generating map data, the method comprising:
receiving data related to an intersection along a roadway, the data comprising:
boundary data describing a boundary around the intersection,
external lane data describing a set of external lanes outside the boundary of the intersection, and
traffic control data describing a set of traffic controls positioned around the intersection;
selecting a set of internal lane types for a corresponding set of internal lanes of the intersection based on the external lane data and the traffic control data;
generating internal lane data describing the set of internal lanes, the internal lane data further based on the boundary data; and
updating a map database to include the internal lane data.

2. The computer implemented method of claim 1, further comprising:
transmitting at least a portion of data in the updated map database to an autonomous vehicle (AV); and
autonomously routing the AV through the intersection based on the internal lane data.

3. The computer implemented method of claim 1, wherein generating the internal lane data for an internal lane comprises generating lane geometry data based on the boundary data, the lane geometry data comprising a lane boundary or a center line for the internal lane.

4. The computer implemented method of claim 1, wherein the internal lane data comprises a plurality of pathways through the intersection, each pathway of the plurality of pathways having a respective entrance point and exit point along the boundary around the intersection, and each pathway of the plurality of pathways having a respective direction of travel.

5. The computer implemented method of claim 1, further comprising:
retrieving an image of the intersection;
generating, in a user interface, a display comprising the image of the intersection and a representation of the internal lane data; and
receiving, via the user interface, a confirmation from a user that the representation of the internal lane data is correct.

6. The computer implemented method of claim 1, further comprising:
retrieving an image of the intersection;
generating, in a user interface, a display comprising the image of the intersection and a representation of the internal lane data;
receiving, via the user interface, a change to the internal lane data; and
updating the map database based on the received change to the internal lane data.

7. The computer implemented method of claim 1, wherein the intersection is a first intersection, the method further comprising:
identifying a second intersection having:
second external lane data matching at least a portion of the external lane data of the first intersection, and
second traffic control data matching at least a portion of the traffic control data of the first intersection;
retrieving second internal lane data associated with the second intersection; and
generating the internal lane data further based on the second internal lane data.

8. A non-transitory computer-readable medium storing instructions that, when executed by a processor, cause the processor to:
receive data related to an intersection along a roadway, the data comprising:
boundary data describing a boundary around the intersection,
external lane data describing a set of external lanes outside the boundary of the intersection, and
traffic control data describing a set of traffic controls positioned around the intersection;
select a set of internal lane types for a corresponding set of internal lanes of the intersection based on the external lane data and the traffic control data;
generate internal lane data describing the set of internal lanes, the internal lane data further based on the boundary data; and
update a map database to include the internal lane data.

9. The computer-readable medium of claim 8, the instructions further causing the processor to transmit at least a portion of data in the updated map database to an autonomous vehicle (AV); wherein the AV autonomously drives through the intersection based on the internal lane data.

10. The computer-readable medium of claim 8, wherein generating the internal lane data for an internal lane comprises generating lane geometry data based on the boundary data, the lane geometry data comprising a lane boundary or a center line for the internal lane.

11. The computer-readable medium of claim 8, wherein the internal lane data comprises a plurality of pathways through the intersection, each pathway of the plurality of pathways having a respective entrance point and exit point along the boundary around the intersection, and each pathway of the plurality of pathways having a respective direction of travel.

12. The computer-readable medium of claim 8, the instructions further causing the processor to:
retrieve an image of the intersection;
generate, in a user interface, a display comprising the image of the intersection and a representation of the internal lane data; and
receive, via the user interface, a confirmation from a user that the representation of the internal lane data is correct.

13. The computer-readable medium of claim 8, the instructions further causing the processor to:
retrieve an image of the intersection;
generate, in a user interface, a display comprising the image of the intersection and a representation of the internal lane data;
receive, via the user interface, a change to the internal lane data; and
update the map database based on the received change to the internal lane data.

14. The computer-readable medium of claim 8, wherein the intersection is a first intersection, the instructions further causing the processor to:
identify a second intersection having:
second external lane data matching at least a portion of the external lane data of the first intersection, and
second traffic control data matching at least a portion of the traffic control data of the first intersection;
retrieve second internal lane data associated with the second intersection; and
generate the internal lane data further based on the second internal lane data.

15. A system comprising:
a map database storing data related to an intersection along a roadway, the data comprising:
boundary data describing a boundary around the intersection,
external lane data describing a set of external lanes outside the boundary of the intersection, and
traffic control data describing a set of traffic controls positioned around the intersection; and
a processor to:
select a set of internal lane types for a corresponding set of internal lanes of the intersection based on the external lane data and the traffic control data,
generate internal lane data describing the set of internal lanes, the internal lane data further based on the boundary data, and
update a map database to include the internal lane data.

16. The system of claim 15, the processor further to transmit at least a portion of data in the updated map database to an autonomous vehicle (AV), wherein the AV autonomously drives through the intersection based on the internal lane data.

17. The system of claim 15, wherein generating the internal lane data for an internal lane comprises generating lane geometry data based on the boundary data, the lane geometry data comprising a lane boundary or a center line for the internal lane.

18. The system of claim 15, wherein the internal lane data comprises a plurality of pathways through the intersection, each pathway of the plurality of pathways having a respective entrance point and exit point along the boundary around the intersection, and each pathway of the plurality of pathways having a respective direction of travel.

19. The system of claim 15, the processor further to:
retrieve an image of the intersection;
generate, in a user interface, a display comprising the image of the intersection and a representation of the internal lane data; and
receive, via the user interface, a confirmation from a user that the representation of the internal lane data is correct.

20. The system of claim 15, the processor further to:
retrieve an image of the intersection;
generate, in a user interface, a display comprising the image of the intersection and a representation of the internal lane data;
receive, via the user interface, a change to the internal lane data; and
update the map database based on the received change to the internal lane data.
